(19) United States
(12) Patent Application Publication
(10) Pub. No.: US 2026/0134305 A1
(43) Pub. Date: May 14, 2026

(54) KNOWLEDGE GRAPH-ENHANCED RETRIEVAL AUGMENTED GENERATION ENGINE

(71) Applicant: eBay Inc., San Jose, CA (US)

(72) Inventors: Petar RISTOSKI, Morgan Hill, CA (US); Zhejun Shen, San Jose, CA (US); Qunzhi Zhou, San Jose, CA (US); Zihao Xu, Edison, NJ (US); Zhe Wu, Mountain View, CA (US)

(21) Appl. No.: 19/090,103

(22) Filed: Mar. 25, 2025

Related U.S. Application Data
(60) Provisional application No. 63/718,430, filed on Nov. 8, 2024.

(51) Int. Cl. G06N 5/025; G06N 3/042; G06N 3/08

(52) U.S. Cl. CPC G06N 5/025; G06N 3/042; G06N 3/08

(57) ABSTRACT

Some aspects of the present technology relate to technologies for performing knowledge graph-enhanced retrieval augmented generation for an e-commerce platform. In accordance with some configurations, a task specification comprising a task and a task input is obtained. This task specification is used to perform entity linking to extract task-aware context. In accordance with some configurations, the task-aware content is concatenated with the task specification to generate a prompt to a large-language model, which uses the prompt as input to generate a response to the task. In some configurations, the response is provided using a user interface.

### CROSS-REFERENCE TO RELATED APPLICATIONS

This non-provisional patent application claims priority to U.S. Provisional Patent Application No. 63/718,430, filed on Nov. 8, 2024, and titled “KNOWLEDGE GRAPH-ENHANCED RETRIEVAL AUGMENTED GENERATION ENGINE,” the entire contents of which are incorporated by reference herein.

### BACKGROUND

Large-Language Models (LLMs) have become increasingly prevalent to perform various language modeling and natural language processing tasks. These LLMs are typically based on language corpuses comprising a significant amount of data. As LLMs become larger, more complex, and more ubiquitous, the models can respond to a wider variety of general queries but can become less suited to processing domain specific queries. For example, an organization may have a large amount of proprietary data that it needs to be incorporated into a LLM for processing domain specific queries. Retraining an existing LLM to incorporate this proprietary data is costly and time-consuming. Additionally, incorporating proprietary data into a public, or open, LLM may not be possible due to the sensitive nature of the data. Maintaining multiple versions of a large LLM can require considerable computing resources and can be prone to errors as the different LLMs diverge.

### SUMMARY

Various aspects of the present technology relate to, among other things, using a knowledge graph-enhanced (KG-enhanced) retrieval augmented generation (RAG) approach. This KG-enhanced RAG approach can be tailored to an item listing system so that, for example, tasks related to using the item listing system (for example, by a consumer of the domain) can be performed using this KG-enhanced RAG approach. A relationship-rich inventory-based Knowledge Graph can be used to identify relevant knowledge for a given task input and task. This identification of relevant knowledge is performed using entity linking and KG embeddings. This entity linking and KG embeddings can then be injected into an LLM prompt, to generate responses to tasks in the item listing system. Advantageously, the power of LLMs for natural language processing is combined with the domain knowledge in the knowledge graph to permit quick and easy access to proprietary factual knowledge to generate high-quality results. This combination considerably reduces LLM hallucinations and generic outputs.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present technology is described in detail below with reference to the attached drawing figures, wherein:

FIG. 1 provides a block diagram illustrating an exemplary system for performing knowledge graph-enhanced retrieval augmented generation for e-commerce, in accordance with some implementations of the present disclosure;

FIG. 2 provides a block diagram illustrating an example framework for performing knowledge graph-enhanced retrieval augmented generation for e-commerce, in accordance with some implementations of the present disclosure;

FIG. 3 provides a block diagram illustrating an example task specification and results, in accordance with some implementations of the present disclosure;

FIG. 4 provides a block diagram illustrating an example knowledge graph content extraction, in accordance with some implementations of the present disclosure;

FIG. 5 provides a block diagram illustrating an example extraction of semantically similar entities, in accordance with some implementations of the present disclosure;

FIG. 6 provides a block diagram illustrating example task specifications, in accordance with some implementations of the present disclosure;

FIG. 7 provides flow diagram showing a method for performing knowledge graph-enhanced retrieval augmented generation for e-commerce, in accordance with some implementations of the present disclosure;

FIG. 8 provides a block diagram of an exemplary item listing system computing environment suitable for use in implementing aspects of the technology described herein;

FIG. 9 provides a block diagram of an exemplary distributed computing environment suitable for use in implementing aspects of the technology described herein; and

FIG. 10 provides a block diagram of an exemplary computing environment suitable for use in implementations of the present disclosure.

### DETAILED DESCRIPTION

Large-Language Models (LLMs) have demonstrated exceptional capability across a variety of tasks, particularly those tasks associated with user interaction with machine-generated content. However, when dealing with proprietary data, significant challenges arise, notably due to the dynamic nature of such datasets, domain specificity, and legal restrictions on data accessibility. A platform can be updated frequently based on proprietary data (for example, every day, every hour, every minute, or even more frequently). This rapid change in data, coupled with the possibility of restricted access, can predispose public LLMs to inaccuracies and hallucinations, limiting their direct applicability in many specialized domains.

Traditionally, to adapt LLMs for such proprietary data environments, approaches including traditional fine tuning, have been used. For example, knowledge editing, has been used to adapt an LLM. However, this process can be both time-consuming and costly due to the proprietary characteristics of the data involved and, in some aspects, frequent updates that require frequent and costly retraining. Alternatively, retrieval augmented generation (RAG) can be used to provide LLMs with timely and domain-specific information, thus enhancing their performance in specialized tasks. This RAG approach not only circumvents the exhaustive demands of model fine tuning but also can be considerably more economical and efficient, since costly retraining of the LLM is avoided in favor of performing modifications to the knowledge database rather than the model itself.

Traditionally, a knowledge graph (KG) can be used as the basis for this knowledge database because a KG provides a strong ability to organize structured, complex information about entities and their relationships. Additionally, a KG can facilitate the integration of comprehensive knowledge into LLMs effectively by incorporating the results of the KG (for example, extracted task-aware context of the task) into the prompt to the LLM. This approach uses the KG results to generate a more task-aware prompt to the LLM, thereby eliminating the requirement of retraining, or fine tuning, the LLM. Additionally, updating the KG, even with millions of entries, can be performed quickly and efficiently so that the extracted task-aware context associated with the task can remain current and relevant.

Aspects of the technology described herein improve the ability to perform LLM queries related to specific tasks and which can incorporate proprietary and/or rapidly changing data. A generic or off-the-shelf LLM such as ChatGPT can be used, where the LLM is trained on a large corpus of data. Ordinarily, such an LLM would not be trained using proprietary data of an organization and, where such data is frequently updated, this LLM may not be able to keep pace with such updates even if it were continually retrained. However, by embodying such proprietary data in a knowledge database such as a knowledge graph and by updating the knowledge graph with the proprietary data, the LLM would not need to be retrained. Instead, the proprietary data is used to update the knowledge graph, the knowledge graph is used to extract task-aware context for the task, and the task-aware context is incorporated into the prompt to the LLM to generate a response that uses the power of the LLM with the up-to-date proprietary data.

In accordance with some aspects of the technology described herein, a task specification that specifies both a task and inputs to the task is received. This task specification can, for example, include a task to determine aspects and inferences about a certain product with an input that includes information about the product (for example, brand, model, size, color, etc.). The task specification can include a format for a response such as, for example, a request to return a list of all relevant aspects as name-value pairs.

Entity linking is then performed to extract task-aware content from the task specification, using a knowledge graph. For example, a task to determine aspects and inferences about a certain product can use the knowledge graph to perform task-aware context extraction that uses the information about the product as a basis for a search of the knowledge graph to determine up-to-date task-aware context information. Such task-aware context might include task-aware context about the brand (for example, manufacturer “X” produces model “A”, manufacturer “X” produces model “B”, etc.), task-aware context about the model (for example, model “A” has size “n×m”, model “A” has color “blue”, model “A” has color “red”, etc.), and other task-aware context as detailed herein. The task-aware context can be provided as entity triples, as described herein. The task-aware context can be concatenated with the task specification to generate a prompt to the LLM. This prompt is then provided as an input to the LLM so that the LLM can generate a response that is aware of the proprietary data of the organization using the task-aware context from the knowledge graph without retraining the LLM.

Aspects of the technology described herein provide a number of improvements over existing technologies. For instance, updating the KG with proprietary and/or rapidly changing data eliminates the need to retrain the public LLM with potentially sensitive data, eliminates the costly and complex process of maintaining and retraining a proprietary LLM, and efficiently manages frequent data updates. These improvements considerably improve the functioning of a computer system used to perform various e-commerce related tasks.

For example, an item listing platform may have, at any time, millions of listings for many thousand different products. As products are bought and sold, those listings can change nearly every second. Maintaining such domain knowledge in a knowledge graph is fast and accurate, and updating such data can be efficiently performed. This is in contrast to trying to update an LLM to reflect changes to that data, where frequent retraining might be slower than each update. This updating of the knowledge graph considerably improves the accuracy of the proprietary data while considerably reducing the computational requirements of the e-commerce system. However, not updating the LLM can cause the LLM to generate results that do not consider the proprietary data, resulting in generic results or hallucinations (for example, inaccurate results). Since an LLM is an efficient system for many language processing tasks, not being able to take advantage of this technology can yield poor results. By incorporating domain knowledge into the knowledge graph and using the knowledge graph to inform the prompt to the LLM, the item listing platform can efficiently use LLM technology to produce quality results that are task-aware. This combination efficiently uses computing resources, producing a task-aware result that leverages LLM technology while avoiding costly and complex retraining.

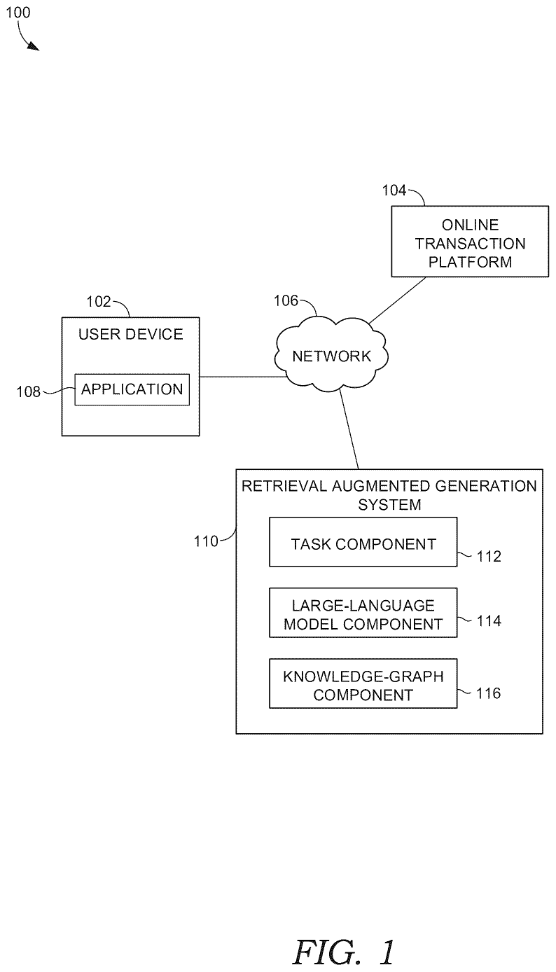

With reference now to the drawings, FIG. 1 provides a block diagram illustrating an exemplary system 100 for performing knowledge graph-enhanced retrieval augmented generation for e-commerce, in accordance with implementations of the present disclosure. It should be understood that this and other arrangements described herein are set forth only as examples. Other arrangements and elements (for example, machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

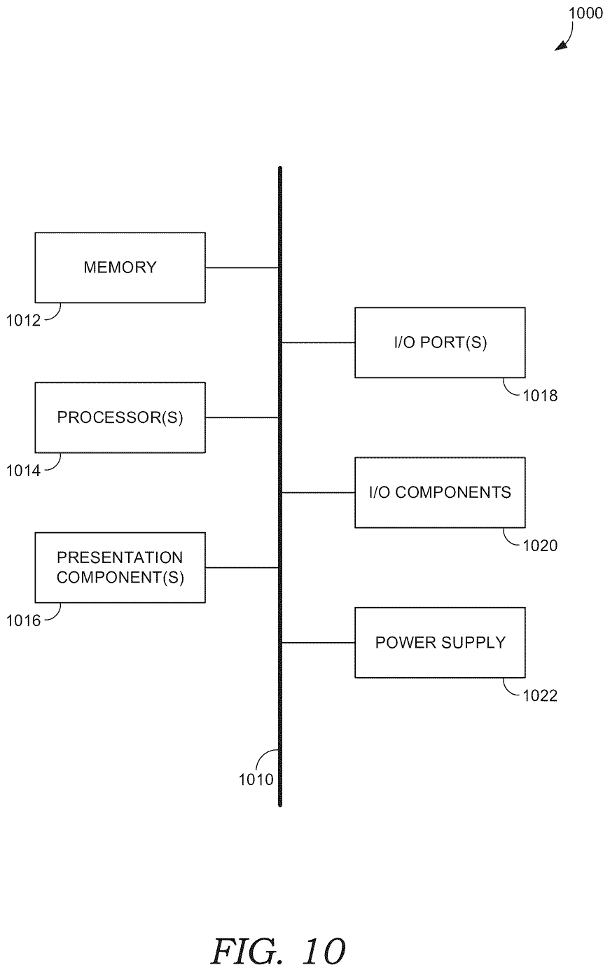

The system 100 is an example of a suitable architecture for implementing certain aspects of the present disclosure. Among other components not shown, the system 100 includes a user device 102, an online transaction platform 104, and a retrieval augmented generation system 110. Each of the user device 102, the online transaction platform 104, and the retrieval augmented generation system 110 shown in FIG. 1 can comprise one or more computer devices, such as the computing device 1000 of FIG. 10, discussed below. As shown in FIG. 1, the user device 102, the online transaction platform 104, and the retrieval augmented generation system 110 can communicate via a network 106, which may include, without limitation, one or more local area networks (LANs) and/or wide area networks (WANs). Such networking environments are commonplace in offices, enterprise-wide computer networks, intranets, and the Internet. It should be understood that any number of user devices and servers may be employed within the system 100 within the scope of the present technology. Each may comprise a single device or multiple devices cooperating in a distributed environment. For instance, the online transaction platform 104 and the retrieval augmented generation system 110 could each be provided by multiple server devices collectively providing the functionality of the online transaction platform 104 and the retrieval augmented generation system 110 as described herein. Additionally, other components not shown may also be included within the network environment.

The user device 102 can be a client device on the client-side of operating environment 100, while the online transaction platform 104 and the retrieval augmented generation system 110 can be on the server-side of operating environment 100. The online transaction platform 104 and/or the retrieval augmented generation system 110 can each comprise server-side software designed to work in conjunction with client-side software on the user device 102 so as to implement any combination of the features and functionalities discussed in the present disclosure. For instance, the user device 102 can include an application 108 for interacting with the online transaction platform 104 and/or the retrieval augmented generation system 110. The application 108 can be, for instance, a web browser or a dedicated application for providing functions, such as interacting with the online transaction platform 104 and/or the retrieval augmented generation system 110. This division of operating environment 100 is provided to illustrate one example of a suitable environment, and there is no requirement for each implementation that any combination of the online transaction platform 104 and the retrieval augmented generation system 110 remain as separate entities. For instance, in some aspects, the retrieval augmented generation system 110 is a part of the online transaction platform 104. While the operating environment 100 illustrates a configuration in a networked environment with a separate user device, online transaction platform, and fraud detection system, it should be understood that other configurations can be employed in which aspects of the various components are combined.

The user device 102 may comprise any type of computing device capable of use by a user. For example, in one aspect, a user device may be the type of computing device 1000 described in relation to FIG. 10 herein. By way of example and not limitation, the user device 102 may be embodied as a personal computer (PC), a laptop computer, a mobile or mobile device, a smartphone, a tablet computer, a smart watch, a wearable computer, a personal digital assistant (PDA), an MP3 player, global positioning system (GPS) or device, video player, handheld communications device, gaming device or system, entertainment system, vehicle computer system, embedded system controller, remote control, appliance, consumer electronic device, a workstation, or any combination of these delineated devices, or any other suitable device. A user may be associated with the user device 102 and may interact with the online transaction platform 104 and/or the retrieval augmented generation system 110 via the user device 102.

The online transaction platform 104 can be implemented using one or more server devices, one or more platforms with corresponding application programming interfaces, cloud infrastructure, and the like. The online transaction platform 104 generally comprises any computer-based system that facilitates electronic transactions over the network 106 via user devices, such as the user device 102. In some aspects, the online transaction platform 104 comprises a listing platform (for example, an e-commerce platform) that generally provides, to the user device 102, item listings describing items (physical or digital) available for purchase, rent, streaming, download, etc., and facilitates electronic purchase transactions for items. In other aspects, the online transaction platform 104 comprises a payment platform that facilitates electronic payment transactions between two accounts. In still further aspects, the online transaction platform 104 comprises a banking platform that facilitates the electronic transfer of money between accounts. In some aspects, the online transaction platform 104 is an e-commerce platform such as those described herein.

As described in further detail below, the retrieval augmented generation system 110 generates responses to tasks between a user device, such as the user device 102, and an online transaction platform, such as the online transaction platform 104. The components of the retrieval augmented generation system 110 may be in addition to other components that provide further additional functions beyond the features described herein. The retrieval augmented generation system 110 can be implemented using one or more server devices, one or more platforms with corresponding application programming interfaces, cloud infrastructure, and the like. While the retrieval augmented generation system 110 is shown separate from the online transaction platform 104 and the user device 102 in the configuration of FIG. 1, it should be understood that in other configurations, some of the functions of the retrieval augmented generation system 110 can be provided on the online transaction platform 104 and/or the user device.

In some aspects, the functions performed by components of the retrieval augmented generation system 110 are associated with one or more applications, services, or routines. In particular, such applications, services, or routines may operate on one or more user devices, servers, may be distributed across one or more user devices and servers, or be implemented in the cloud. Moreover, in some aspects, these components of the retrieval augmented generation system 110 may be distributed across a network, including one or more servers and client devices, in the cloud, and/or may reside on a user device. Moreover, these components, functions performed by these components, or services carried out by these components may be implemented at appropriate abstraction layer(s) such as the operating system layer, application layer, hardware layer, etc., of the computing system(s). Alternatively, or in addition, the functionality of these components and/or the aspects of the technology described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regards to specific components shown in example system 100, it is contemplated that in some aspects, functionality of these components can be shared or distributed across other components.

The retrieval augmented generation system 110 receives tasks (for example, from the user device 102 and/or the online-transaction platform 104) and generates responses to those tasks that may be presented to the user device 102 and/or the online transaction platform 104. The tasks and/or the responses can generally comprise any information regarding user interaction, via the user device 102 (in some cases, using the application 108), with the online transaction platform 104. In some configurations, the online transaction platform 104 is a website or web application that provides one or more pages (i.e., user interfaces) that are presented via the user device 102 and allow for user interaction (for a business user).

The retrieval augmented generation system 110 illustrated in FIG. 1 includes a task component 112, a large-language model component 114, and/or a knowledge-graph component 116. The task component 112 receives a task specification (for example, comprising a task and/or task input) and generates queries to the large-language model component 114 and the knowledge-graph component 116. The task component 112 and the knowledge-graph component 116 use the task specification to perform entity linking by using the knowledge-graph component 116 to extract task-aware context information, as described below. The task component 112 combines the task-aware context information with the task specification to generate a prompt. The prompt is then provided to the large-language model component 114, which performs natural language processing to generate a response to the task specification. The response to the task specification is provided to the user device 102 using a user interface (not shown) of the application 108.

As described herein, augmenting an LLM with a knowledge graph comprises two steps: extracting relevant subgraphs from the knowledge graph according to the query and subsequently incorporating this information into the LLM. In general, subgraph retrieval frameworks are divided into two types: non-agent-based and agent-based. A non-agent-based approach follows a set schema, including identifying relevant entities within the graph, constructing subgraphs, and pruning the results. In general, entity resolution can be performed using either rule-based systems or embedding-based representations. Subgraph construction can include simple techniques such as one-hop graph retrieval (for example, only closest neighbors are retrieved to form the subgraph), more sophisticated methods like using a Prize-Collecting Steiner Tree (for example, finding a connected subgraph that maximizes one or more profit metrics), or other such methods. On the other hand, agent-based retrieval is characterized by the use of a decision-making agent, often an agent associated with an LLM, to guide the retrieval process. This agent typically formulates a retrieval plan based on the initial query. A graph database is then used to execute this plan and provide results. The agent evaluates the outcomes and iteratively refines the plan, engaging in multiple rounds of interaction with the graph database to enhance the retrieval quality.

Incorporating subgraph data into a LLM can be achieved through the use of either hard or soft prompts. Hard prompts, also known as verbalizations, involve translating graph information into natural language text, which is then appended to the input prompt of the LLM. One method, KAPING (Knowledge-Augmented language model PromptING), concatenates the subject, relation and object triple and directly appends it to input prompt. Another method, GNN-RAG (Graph Neural Network using Retrieval-Augmented Generation), reasons over subgraphs and retrieves the answer entities and incorporates a question into answer entity paths. Given the proficiency of LLMs in interpreting natural language, no further training is required in this phase, enhancing efficiency of the LLM and the data incorporation. However, plain text may not fully capture the complex structures of some graphs. Soft prompts address this by converting subgraph information into a latent representation that is consistent with the LLM's intrinsic framework. One approach involves freezing the LLM's parameters and training a graph neural network (GNN) to output a graph encoding that is compatible with the LLM's embedding. Another approach augments this process with cross-modality pooling and a projection mechanism alongside the GNN encoder. This approach can also introduce a self-supervised entity-linking prediction loss to capture the inter-entity relations and structural nuances of the graph.

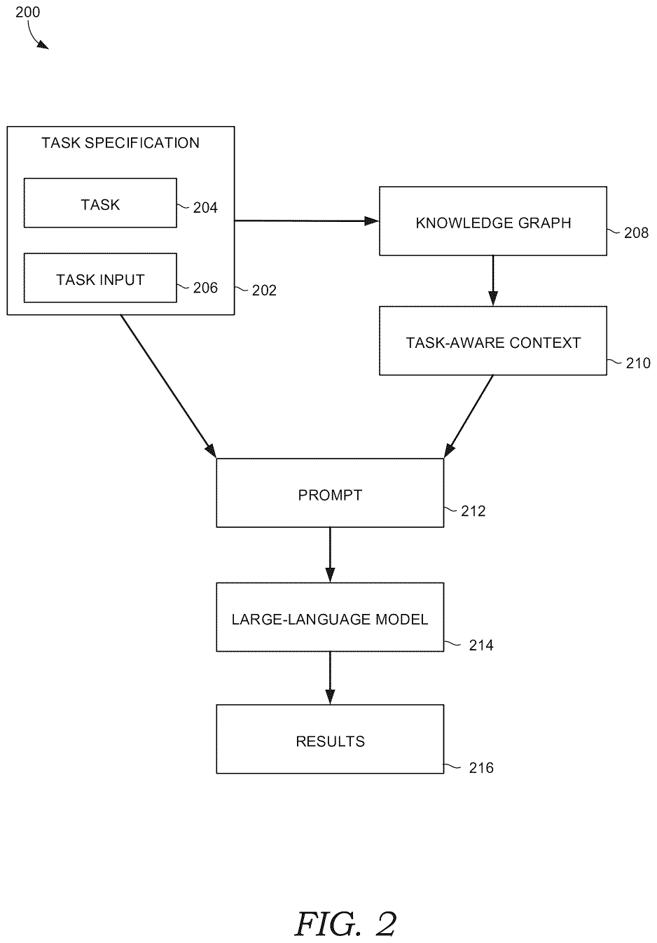

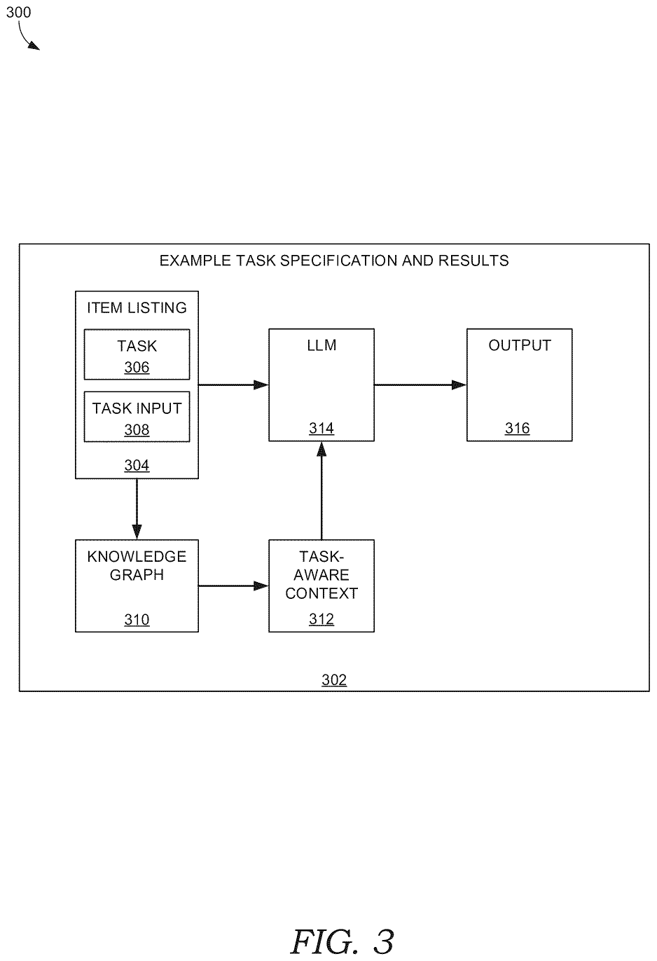

With reference to FIG. 2, FIG. 2 provides a block diagram 200 is provided that illustrates an example framework for performing knowledge graph-enhanced retrieval augmented generation for an item listing system, in accordance with some implementations of the present disclosure. The framework illustrated in FIG. 2 receives a task specification 202 that comprises a task 204 and task input 206. In some aspects task 204 and task input 206 are described in a natural language. Task input 206 can be a product title or a search query, on which the task 204 is to be executed. In an example, illustrated in FIG. 3, the framework is asked to perform “aspect-value pairs extraction and inference” on a short product title “Apple 6.1 inch A17 pro”. In an aspect, entity linking is performed on the on the task input 206, to identify all knowledge graph 208 entities based, at least in part, on task input 206. Based on the extracted entities, and the task 204, task-aware context 210 is extracted from the knowledge graph 208. In some aspects, this task-aware content 210 is extracted in a natural language format. The task-aware context 210 is then concatenated with the task 204 and the task input 206 to construct a prompt 212 for the large-language model 214. The large-language model 214 then generates results 216. In some aspects, prompt 212 is a prompt to a LLM that is generated as described herein (for example, by concatenating the task 204, the task input 206, and the task-aware context 210). In some aspects, not shown in FIG. 2, results 216 are generated in a requested format, which is specified as an element of task specification 202. Further details of the example framework for performing knowledge graph-enhanced retrieval augmented generation for e-commerce are provided in connection with the example task specification and results illustrated in FIG. 3.

FIG. 3 provides a block diagram 300 illustrating an example task specification and results 302, in accordance with some implementations of the present disclosure. A framework such as the framework described in connection with FIG. 2 accepts an item listing 304 comprising a task 306 and a task input 308. Task 306 and task 308 can be described in natural language so, for example, a task 306 can be to “extract all explicit and implicit entities” and task input 308 can be “Apple 6.1 inch A17 Pro.” Task input 308 can be a product title or a search query, on which the task 306 is to be executed. In this example, the model is asked to perform a task 306 to “extract all explicit and implicit entities” on task input 308, “Apple 6.1 inch A17 Pro”. Then, entity linking is performed on the task input 308 to identify knowledge graph entities (denoted V_{q}, for a task input q) from the knowledge graph 310. Based on the extracted entities V_{q} of the task input 308 and the given task 306, relevant task-aware context 312 is extracted from the knowledge graph 310 in a natural language format. The task-aware context 312 is then concatenated with the task 306 and task input 308 to construct the final prompt for the LLM 314. Finally, the LLM generates the output 316 in the requested format, which may be specified as part of the task 306.

As used herein, a knowledge graph 310 is a labeled, directed graph G=(V, E), where V is a set of vertices, and E is a set of directed edges, where each vertex ν∈V is identified by a unique identifier, and each edge e∈E is labeled with a label from a finite set of edge labels. Each edge e∈E can also include an edge weight, described below. In some embodiments, a relationship-rich product knowledge graph is used, where data in the knowledge graph is mined from user provided data. This product knowledge graph can be used to capture entities and relationships between those entities to model a product inventory of, for example, an item listing system. For example, this product knowledge graph can be created from data that is mined from millions of product listings based on co-occurring aspect-value pairs in product listings, resulting in a directed weighted graph. In some embodiments, a node in this product knowledge graph can be generated for each aspect-value pair (for example, an identified aspect such as a “Model” and a value for that aspect such as “iPhone 15 Pro Max”) that occurs in product listings. In some embodiments, an aspect can have multiple values and, thus, multiple aspect-pairs (for example, [“Model”, “iPhone 15 Pro Max”] and [“Model”, “iPhone 15 Pro”]). In some embodiments, only a subset of the aspect-value pairs are used (for example, those that are above a specified threshold). Moreover, in some embodiments, to set the edge weights of the product knowledge graph, for each co-occurring pair of aspect-value pair in at least one product listing, a normalized co-occurrence frequency can be calculated. In some embodiments, this co-occurrence frequency can be normalized by the occurrence of both nodes in each direction, resulting in directed weights.

In some aspects, RDF2vec, an approach that uses language modeling approaches for unsupervised feature extraction from sequences of words, and adapts them to resource description format (RDF) graphs, can be used to generate embedding vectors for all entities and relations. Biased walks can be performed on a weighted graph to flatten the graph in sequences that can later be embedded using a language model (for example, an LLM). This approach is able to capture the neighborhood of each entity in a single vector, which then can be used for similarity calculation or context inference.

In order to extract relevant task-aware context 312 for the given task 306 and task input 308, first knowledge graph 310 entities in the task input 308 are identified. This can be performed using entity linking. As used herein entity linking identifies textual mentions of named entities in the input, and aligns them to their corresponding entities in the knowledge graph. Entity linking resolves the lexical ambiguity of textual mentions and determines concrete meaning. The output of the entity linking pipeline is a set of extracted entities for the given input q, V_{q}={ν₁, ν₂, . . . , νₙ}, where q is the task input 308 and V_{q} is the knowledge graph entities for task q. In some aspects, when knowledge graph entities are extracted, they can be used to access related information, including information about each entity, as well as the surrounding neighborhood structure and the neighboring entities.

In the task-aware context 312, denoted C, we first add all identified entities Eq using a normalized label in, for example, natural language format. In the example illustrated in FIG. 3, “Brand: Apple, Screen Size: 6.1 inch, Chipset: A17 Pro” were identified. Two different types of context (for example, neighboring entities and semantically similar entities) can be attached.

To identify relevant task-aware context C (task aware context 312) for the given task t (task 306) the direct neighbors of the extracted set of entities V_{q} are explored. To do so, for each entity νᵢ∈Vₜ, the direct neighboring entities Uₜ are retrieved using the knowledge graph 310. These direct neighboring entities include both incoming and outgoing edge weights, resulting in a set of triples Uₜ={(u₁, e_{νu1}, e_{uν1}), (u_{nz}, e_{νu2}, e_{uν2}), . . . , (uₙ, e_{νun}, e_{uνn})}, where uᵢ is the neighboring entity, e_{νui} is the outgoing edge weight, and e_{uνi} is the incoming edge weight. In some aspects, after all the neighboring entities are extracted, an iteration over the complete list of entities U is performed so that the edge weights (for both outgoing and incoming edges) are aggregated such that the outgoing score for each neighboring entity u is calculated as

$${w}_{uout} = {\sum }_{i = 1}^{n} \frac{{e}_{u v i}}{\vert U \vert}$$

and the incoming score is calculated as

$${w}_{uin} = {\sum }_{i = 1}^{n} \frac{{e}_{vui}}{\vert U \vert} .$$

The final score wᵤ for each entity u is then calculated as

$${w}_{u} = \frac{( {w}_{uout} + {w}_{uin} )}{2} .$$

The entities can then be sorted in descending order based on the final score, and the top K entities are selected, where K is calculated based on the context window of the LLM 314.

In some aspects, the final prompt to the LLM is generated by concatenating the task-aware context C (task-aware context 312) with the task t (task 306) and the task input q (task input 308). In some aspects, the task-aware context C (task-ware context 312) can be a combination of the previously described context retrieval approaches. The final prompt is then provided as an input to an LLM such as, for example, Llama, Mistral, or ChatGPT.

In some aspects, not shown in FIG. 3, the task-aware context 312 comprises a set of entity triples such as [{Apple}, {Produces Model}, {iPhone 15 Pro}, {Apple}, {Produces Model}, {iPhone 15 Pro Max}, {Apple}, {Has Phone With}, {Operating System iOS}, {Screen 6.1}, {Is Used In}, {iPhone 15 Pro}, {A17 Pro Chipset}, {Is Used In}, {iPhone 15 Pro}, {A17 Pro Chipset}, {Is Used In}, {iPhone 15 Pro Max}, . . . ]. These entity triples can be used to generate the prompt to the LLM 314, as described above.

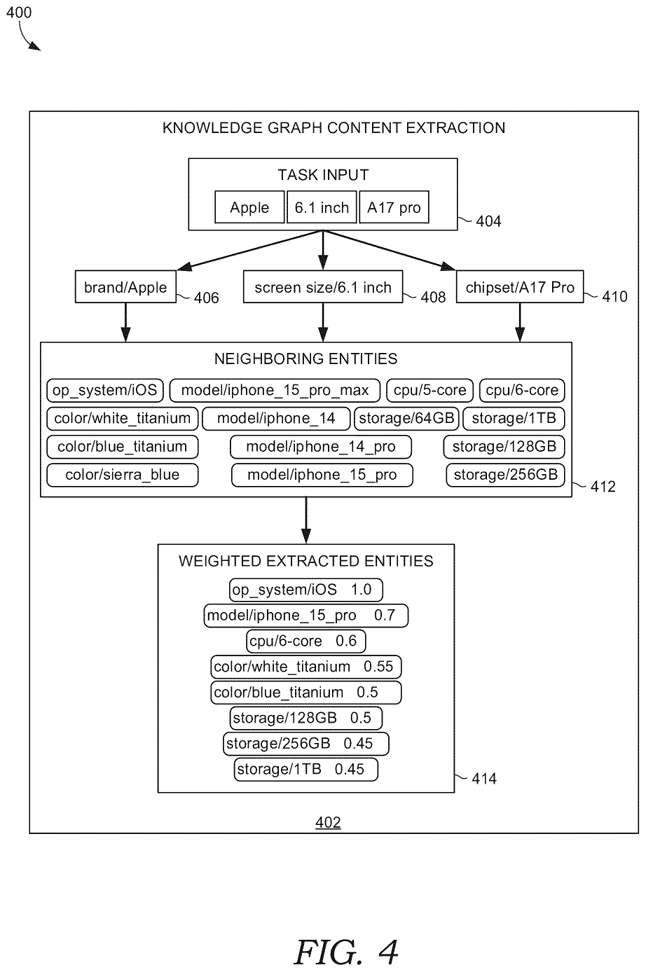

FIG. 4 provides a block diagram 400 illustrating an example knowledge graph content extraction 402, in accordance with some implementations of the present disclosure. Continuing with example described in connection with FIG. 3, for each neighboring entity a factual knowledge entry list in natural language format is generated. FIG. 4 illustrates the extraction of neighboring entities 412 for the previous example input (for example, task 306 and task input 308). In some aspects, not shown in FIG. 4, a neighboring subgraph is first extracted, and then this neighboring subgraph is aggregated so that the top K entities are returned as the final context, as described above. The task input 404 is the same as task input 308. The entities (“brand/Apple” 406, “screen size/6.1 inch” 408, and “chipset/A17 pro” 410) are extracted, and neighboring entities 412 are extracted from these entities. Then for each neighboring entity, a fact is generated (for example, “Brand Apple produces cellphones with iOS operating system”, as illustrated in FIG. 3). The knowledge graph is divided by category, thereby enabling the construction of rules for improving verbalizing of the triples so that, as in this example, the category “cellphones” can be used to improve the natural language verbalization. As shown in FIGS. 3 and 4, this aggregation enables the most relevant knowledge to be displayed at the beginning of the list so that, for example, given the input t and q, it can be inferred from the weighted extracted entities 414 that the phone has an operating system “iOS” (weight 1.0), the model is an “iPhone 15 Pro” (weight 0.7), with a “6-core” CPU (weight 0.6), with multiple color options (weights 0.55 and 0.5), and multiple storage capacities (weights 0.5, 0.45, and 0.45).

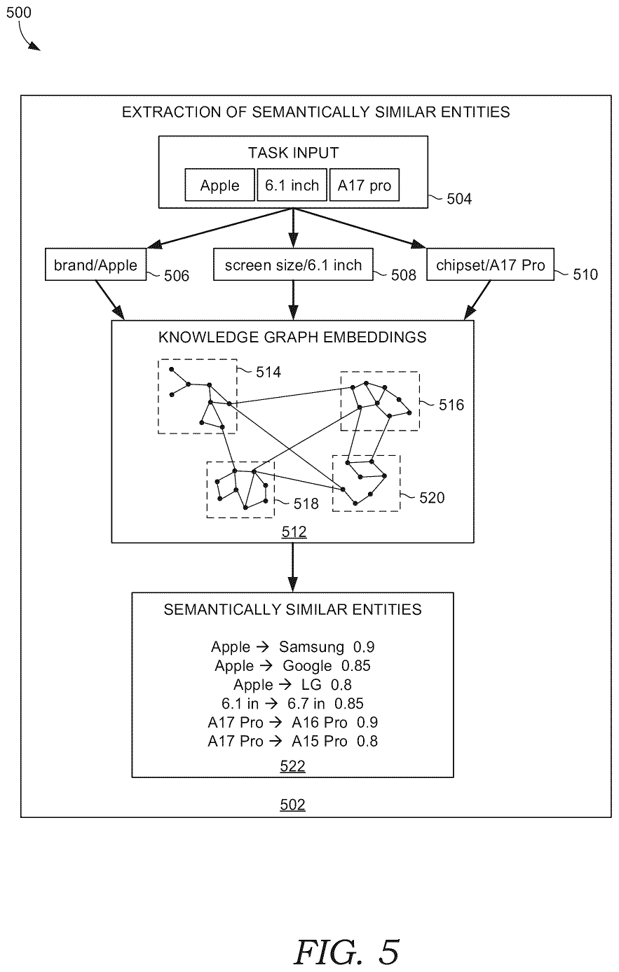

FIG. 5 provides a block diagram 500 illustrating an example extraction of semantically similar entities 502, in accordance with some implementations of the present disclosure. In many item listing system tasks, such as query expansion or rewriting, it can be important to identify semantically similar entities to the entities in the task input 504 (task input q). Previously built knowledge graph embeddings 512 can be used to calculate cosine similarity between the extracted set of entities Vt and the remaining entities in the knowledge graph. In the example illustrated in FIG. 5, knowledge graph embedding 516 is related to entity 506 (“brand/Apple”), knowledge graph embedding 518 is related to entity 508 (“screen size/6.1 inch”), and knowledge graph embedding 520 is related to entity 510 (“chipset/A17 Pro”). One or more other knowledge graph embedding such as knowledge graph embedding 514, which are not related to any entities, can also be present in knowledge graph embedding 512. For each extracted entity Vt the top M semantically similar entities from the graph Uₛ={u₁, u₂, . . . , uₘ} are identified, as represented by semantically similar entities 522, again where M is based on the size of the context window of the LLM. Then for each entity the set of similar entities is verbalized and that is used to generate the final context. For example, FIG. 5 shows that for the previously extracted “Brand: Apple” the context “Brand Apple is similar to: Samsung, Google and LG” is generated with weights of 0.9, 0.85, and 0.8 respectively. This context can then be appended to the previously extracted context C, described above.

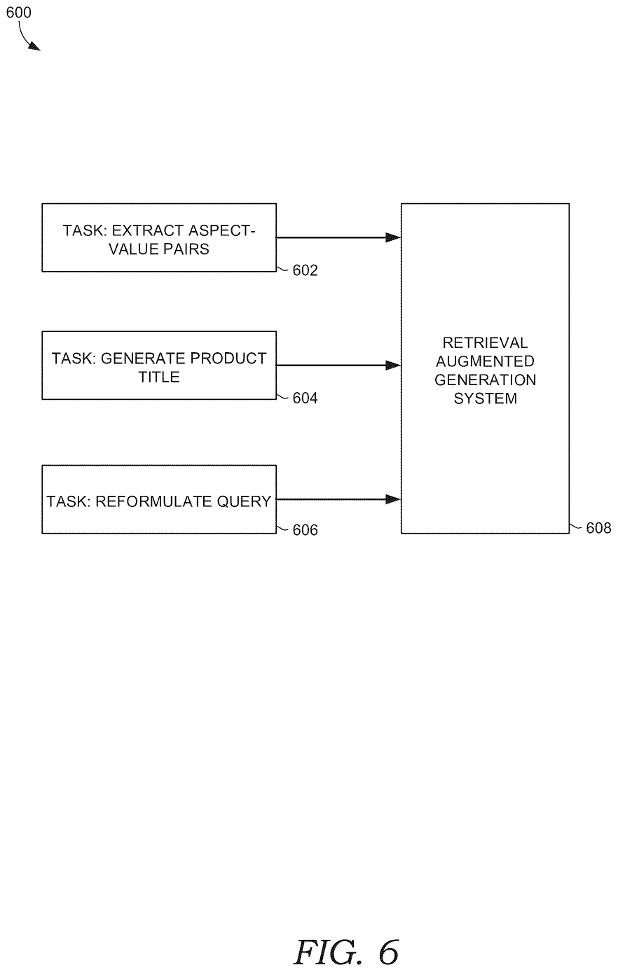

FIG. 6 provides a block diagram 600 illustrating example task specifications, in accordance with some implementations of the present disclosure. As a first example task specification, a task 602 to extract aspect value pairs is used as input to a retrieval augmented generation system 608, which is a retrieval augmented generation system such as retrieval augmented generation system 110, described in connection with FIG. 1. In the interest of clarity, task input q associated with task 602 is not shown in FIG. 6. When listing new products on an e-commerce platform, besides title and description, a user (for example, a seller) is asked to provide product specifics in the format of aspect-value pairs. While having detailed product specifics is important when determining how and when to show an item to buyers (referred to as surfacing) and important to having positive transaction metrics, requesting that a seller fill out all product specifics is a very common reason for a sellers to abandon the listing flow. Primarily there are three main reasons for this abandonment: (i) sellers are not familiar with all the product specifics they are asked to fill out (e.g. model numbers, etc.), (ii) the product specifics are redundant to what the seller has already provided in the product title or description, and (iii) the product specifics are obvious and could be inferred from the product title or description (e.g. if the seller already specified they are selling “iPhone”, the brand of the product can be easily inferred to “Apple”). To ease the listing process, an e-commerce platforms can assist the sellers in filling out product specifics, using aspect-value extraction and inference as described herein. A task such as task 602, to extract aspect value pairs for a given task input (for example, given a generated title for a listing such as “Apple iphone 15 Pro”), can be performed using the techniques described herein to automatically generate the most relevant aspect-value pairs for the seller, thus preventing abandonment, improve surfacing, and increase transaction metrics.

A second example task specification is a task 604 to generate a product title is used as input to a retrieval augmented generation system 608. As with task 602, in the interest of clarity, task input q associated with task 604 is not shown in FIG. 6. When listing new products on an e-commerce platform, a seller is requested to add a title that summarizes the most important specifics of the product. In some aspects, a seller can start the listing flow by issuing a search query which allows them to browse the existing inventory for potential matches, allowing them to copy an existing product, instead of generating a listing for a new product from scratch. In cases where a seller does not find a match, the seller may need to provide a full title, a description and other item specifics. Given that a seller has already provided a search query, a task such as task 604, to generate a product title based on the previously search query can be performed by the e-commerce system to generate a title that contains the most relevant information. For example, given a product search query “124300”, which is a wristwatch reference number, a task 604 to generate a product title can be performed using this search query as a query input to generate a suggested title such as “Rolex Oyster Perpetual 124300 Black Dial 41 mm Stainless Steel” and provide this title as a suggestion to the seller. A task such as task 604, to generate a product title for a given task input (for example, given a product search query “124300”), can be performed using the techniques described herein to automatically generate an informative title for a seller, thus improving platform engagement and improving transaction metrics.

A third example task specification is a task 606 to reformulate a query is used as input to a retrieval augmented generation system 608. As with task 602 and task 604, in the interest of clarity, task input q associated with task 604 is not shown in FIG. 6. One important task for an e-commerce search engine is to semantically match a user query to items in the product inventory and retrieve the most relevant items that match the user's intent. In some aspects, this task is complicated by the fact that there often can be a mismatch between a user's intent and the product inventory. To bridge the semantic gap between the user's intent and the available product inventory, a task such as task 606 to reformulate a query can be used. Such approaches use a combination of token dropping, token replacement, and token expansion. Token replacement for query reformulation can be effecting in low-inventory recovery, as well as product recommendations. For example, if a user is searching for “Nike sneakers” but there are not enough items from the inventory, instead of showing empty result page to the user, a query can be reformulated show other relevant results to the user (for example, “Adidas sneakers” or “Puma sneakers”). In this example the query reformulation is performed by pivoting the brand entity, but it can be done on different types of entities, or multiple entities at the same time. A task such as task 606, to reformulate a query for a given task input (for example, given a product search for “Nike sneakers”), can be performed using the techniques described herein to automatically generate an more complete relevant inventory list for a buyer, thus improving transaction metrics. As may be contemplated, the example task specifications shown in FIG. 6 are illustrative examples and, as such, other such task specifications may be considered as within the scope of the present disclosure.

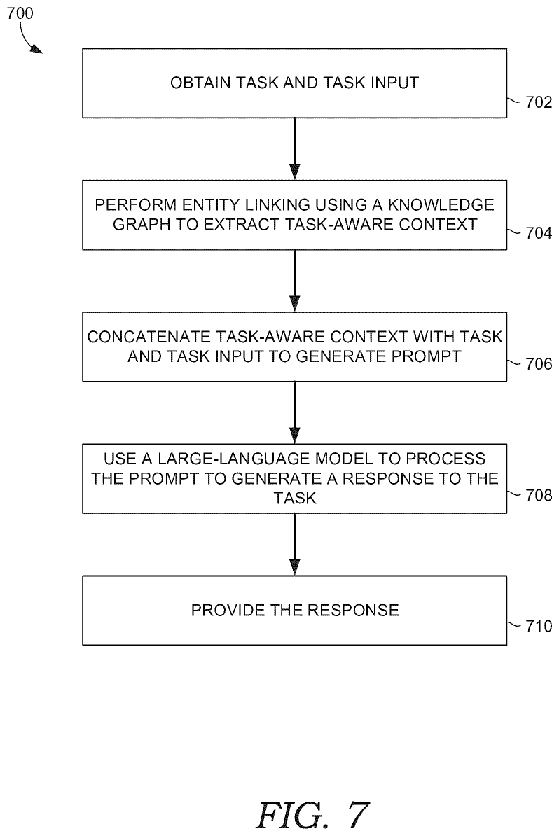

With reference now to FIG. 7, a flow diagram is provided that illustrates a method 700 for performing knowledge graph-enhanced retrieval augmented generation for e-commerce], in accordance with some implementations of the present disclosure. The method 700 can be performed, for instance, by the retrieval augmented generation system 110 of FIG. 1. Each block of the method 700 and any other methods described herein comprises a computing process performed using any combination of hardware, firmware, and/or software. For instance, various functions can be carried out by a processor such as one or more of processor(s) 1014, executing instructions stored in memory such as memory 1012, both described in connection with FIG. 10. The methods can also be embodied as computer-usable instructions stored on computer storage media. The methods can be provided by a standalone application, a service or hosted service (standalone or in combination with another hosted service), or a plug-in to another product, to name a few.

At block 702, a processor performing method 700 performs operations to obtain a task and task input. In some aspects, the operations to obtain a task and task input include operations to obtain a task such as task 204 and task input such as task input 206, both described in connection with FIG. 2. In some aspects, the task and task input received are elements of a task specification such as task specification 202, also described in connection with FIG. 2. In some aspects, operations to obtain a task and task input are performed by a task component such as task component 112 of the retrieval augmented generation system 110 of FIG. 1. In some aspects, after block 702, method 700 continues at block 704.

At block 704, a processor performing method 700 performs operations to perform entity linking using a knowledge graph to extract task-aware context. In some aspects, the operations to perform entity linking using a knowledge graph to extract task-aware content are performed using the task input received at block 702. In some aspects, the operations to perform entity linking using a knowledge graph to extract task-aware content are performed by a knowledge-graph component such as the knowledge-graph component 116 of the retrieval augmented generation system 110 of FIG. 1. In some aspects, after block 704, method 700 continues at block 706.

At block 706, a processor performing method 700 performs operations to concatenate the task-aware context (for example, extracted at block 704) with the task and the task input (for example, obtained at block 702) to generate a prompt to an LLM, as described herein. For example, if a task is to extract aspect-value pairs for task input “Apple 6.1 inch A17 pro” (as described in connection with FIG. 3), and the task-aware context C is as described in connection with FIG. 3, than at block 706, a prompt can be generated that concatenates the natural language verbalizations of task-aware context C with the task and task input of “extract aspect-value pairs for an Apple 6.1 inch A17 pro.” In some aspects, after block 706, method 700 continues at block 708.

At block 708, a processor performing method 700 performs operations to use a large-language model to process the prompt (for example, generated at block 706) to generate a response to the task. In some aspects, the operations to use a large-language model to process the prompt to generate a response to the task are performed by a large-language model component such as the large-language model component 114 of the retrieval augmented generation system 110 of FIG. 1. In some aspects, after block 708, method 700 continues at block 710.

At block 710, a processor performing method 700 performs operations to provide the response (for example, the response to the task produced by the large-language model at block 708, using the prompt generated at block 706 as input). In some aspects, the response is provided to a user interface of an application such as application 108 of user device 102, both of FIG. 1. In some aspects, the response is provided to an online transaction platform such as online transaction platform 104 of FIG. 1. In some aspects, not shown in FIG. 7, the response is used as input for further iterations of the method 700 (for example, to generate further tasks and/or to generate further task input). In some aspects, after block 710, method 700 terminates. In some aspects, not shown in FIG. 7, after block 710, method 700 continues at block 702, to obtain another task and/or task input.

Although not illustrated in FIG. 7, in some configurations, the operations of the method 700 are performed in a different order than that described. In some configurations, where operations can be performed in a different order, some of the operations can be performed in parallel by a plurality of devices such as those described herein. For example, a plurality of blocks of method 700 can be performed sequentially or in parallel by a plurality of threads executing on devices such as those described herein. Similarly, in some configurations, operations can be performed in a batch so that, for example, block 704 can be performed in a batch for a plurality of tasks and task inputs (for example, obtained in block 702). As may be contemplated, other orders in which the operations of method 700 may be considered as within the scope of the present disclosure.

As discussed, in the rapidly evolving world of e-commerce, the ability to provide accurate, up-to-date, and contextually relevant information is important. Traditional Large Language Models (LLMs) have shown exceptional capabilities in natural language understanding and generation, but they face significant challenges when dealing with proprietary, dynamic, and domain-specific data. This is where the innovative Knowledge Graph-Enhanced Retrieval Augmented Generation (KG-RAG) framework comes into play, offering a technical solution to these challenges.

LLMs often struggle with data accessibility, as proprietary data is frequently updated and legally restricted, making it inaccessible to public LLMs. Additionally, fine-tuning LLMs with internal data is both time-consuming and costly. Without access to current and factual data, LLMs can produce inaccurate or hallucinated information. The KG-RAG framework addresses these issues by integrating the strengths of Knowledge Graphs (KGs) with the generative capabilities of LLMs.

A Knowledge Graph-Enhanced Retrieval Augmented Generation (KG-RAG) engine is provided as an advanced system designed to enhance the capabilities of Large Language Models (LLMs) by integrating structured knowledge from Knowledge Graphs (KGs) into the generation process. This engine addresses the limitations of LLMs in handling proprietary, dynamic, and domain-specific data, providing accurate, up-to-date, and contextually relevant outputs.

A KG is a structured representation of knowledge, capturing entities and their relationships in a labeled, directed graph. In this framework, the KG is mined from millions of product listings, creating a rich, relationship-based inventory that models the entire product ecosystem. Retrieval Augmented Generation (RAG) enhances LLMs by retrieving relevant information from the KG and incorporating it into the generation process. This method ensures that the LLMs have access to timely and domain-specific data, significantly improving the accuracy and relevance of their outputs.

Entity linking is performed, where textual mentions of entities in the input are identified and aligned with their corresponding entities in the KG. This process resolves lexical ambiguities and ensures that the correct entities are referenced, providing a solid foundation for context extraction. KG embeddings are vector representations of entities and relationships within the KG. These embeddings capture the neighborhood and structural information of each entity, facilitating similarity calculations and context inference.

The context extraction module retrieves relevant information from the KG based on the identified entities and the specific task. This involves extracting neighboring entities and semantically similar entities, which are then verbalized into natural language facts. This context is crucial for enriching the LLM prompts. The final step involves constructing the prompt for the LLM. This prompt is a concatenation of the task description, input text, and the extracted KG context. By providing the LLM with this enriched prompt, the framework ensures that the generated responses are accurate and contextually relevant.

The KG-RAG framework has been evaluated on three key e-commerce tasks: aspect-value pairs extraction, product title generation, and query reformulation. In aspect-value pairs extraction, the framework automatically extracts and infers product specifications from titles, significantly improving precision and recall. For product title generation, it generates buyer-attractive titles from short search queries, enhancing the appeal and informativeness of product listings. In query reformulation, it modifies user search queries to better match the product inventory, improving search results and user satisfaction.

In both zero-shot and instruction-tuned settings, the KG-RAG framework has demonstrated superior performance compared to baseline LLM models. By combining the natural language understanding capabilities of LLMs with the structured, factual knowledge of KGs, the framework generates high-quality, accurate, and relevant outputs. The Knowledge Graph-Enhanced Retrieval Augmented Generation framework represents a significant advancement in the application of LLMs for item listing system. By seamlessly integrating up-to-date, domain-specific data from Knowledge Graphs, this framework addresses the intrinsic limitations of LLMs, providing a powerful tool for enhancing the accuracy and relevance of generated content. As the item listing system landscape continues to evolve, the KG-RAG framework offers a scalable, efficient, and effective solution for leveraging the full potential of LLMs in specialized domains.

To illustrate, consider a seller listing a new product on eBay: an “Apple iphone 15 Pro with 6.1-inch display and A17 Pro chipset.” The seller provides a short title and brief description but does not fill out all detailed specifications. The input text and task description are processed through the entity linking pipeline, identifying entities like “Apple,” “iPhone 15 Pro,” “6.1 inch,” and “A17 Pro.” The context extraction module retrieves relevant information from the KG, including neighboring entities such as “iOS,” “Hexa-core CPU,” and various storage and color options. This context is used to construct a detailed prompt for the LLM, which then generates a comprehensive list of product specifications. This process not only saves time for the seller but also ensures that the product listing is accurate and informative, enhancing the overall user experience on the platform.

Having described implementations of the present disclosure, an exemplary operating environment in which embodiments of the present technology can be implemented is described below in order to provide a general context for various aspects of the present disclosure. Referring initially to FIG. 10 in particular, an exemplary operating environment for implementing embodiments of the present technology is shown and designated generally as computing device 1000. Computing device 1000 is but one example of a suitable computing environment and is not intended to suggest any limitation as to the scope of use or functionality of the technology. Neither should the computing device 1000 be interpreted as having any dependency or requirement relating to any one or combination of components illustrated.

The technology can be described in the general context of computer code or machine-usable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The technology can be practiced in a variety of system configurations, including hand-held devices, consumer electronics, general-purpose computers, more specialty computing devices, etc. The technology can also be practiced in distributed computing environments where tasks are performed by remote-processing devices that are linked through a communications network.

### ADDITIONAL SUPPORT FOR DETAILED DESCRIPTION OF THE INVENTION

### Example Item Listing System Environment

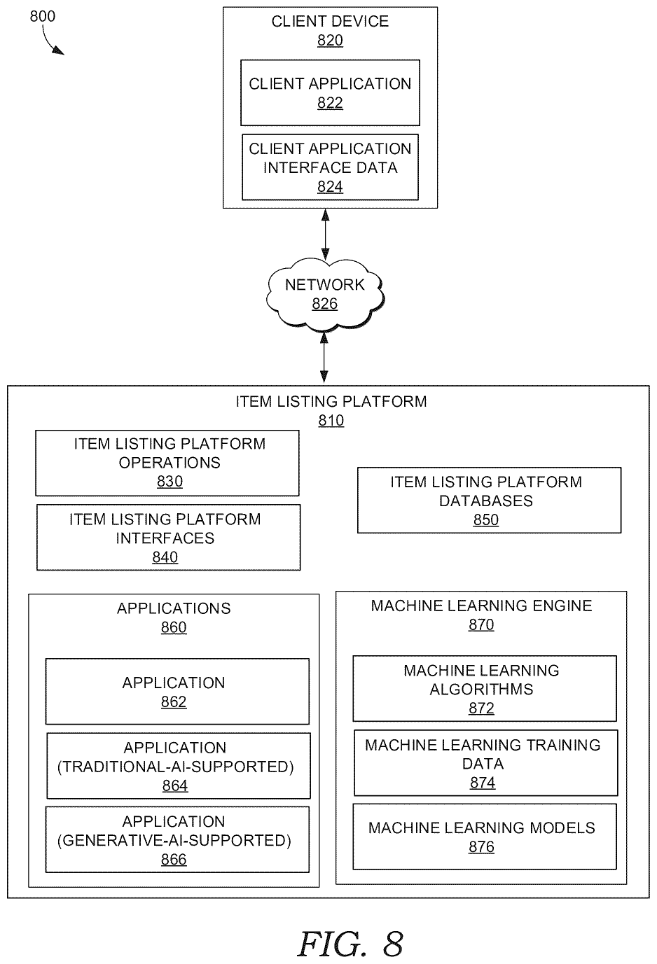

Referring now to FIG. 8, FIG. 8 illustrates an example item listing system 800 computing environment in which implementations of the present disclosure may be employed. In particular, FIG. 8 shows a high level architecture of an example item listing platform 810 that can host a technical solution environment, or a portion thereof. It should be understood that this and other arrangements described herein are set forth as examples. For example, as described above, many elements described herein may be implemented as discrete or distributed components or in conjunction with other components, and in any suitable combination and location. Other arrangements and elements (for example, machines, interfaces, functions, orders, and groupings of functions) can be used in addition to or instead of those shown.

The item listing system 800 can be a cloud computing environment that provides computing resources for functionality associated with the item listing platform 810. For example, the item listing system 800 supports delivery of computing components and services-including servers, storage, databases, networking, applications, and machine learning associated with the item listing platform 810 and client device 820. A plurality of client devices (for example, client device 820) include hardware or software that access resources on the item listing system 800. Client device 820 can include an application (for example, client application 822) and interface data (for example, client application interface data 824) that support client-side functionality associated with the item listing system. The plurality of client devices can access computing components of the item listing system 800 via a network (for example, network 826) to perform computing operations.

The item listing platform 810 is responsible for providing a computing environment or architecture that includes the infrastructure that supports providing item listing platform functionality (for example, e-commerce functionality). The item listing platform support storing item in item databases and providing a search system for receiving queries and identifying search results based on the queries. The item listing platform may also provide a computing environment with features for managing, selling, buying, and recommending different types of items. Item listing platform 810 can specifically be for a content platform such as EBAY content platform or e-commerce platform, developed by EBAY INC., of San Jose, California.

The item listing platform 810 can provide item listing platform operations 830 and item listing platform interfaces 840. The item listing platform operations 830 can include service operations, communication operations, resource management operations, security operations, and fault tolerance operations that support specific tasks or functions in the item listing platform 810. The item listing platform interfaces 840 can include service interfaces, communication interfaces, resource interfaces, security interfaces, and management and monitoring interfaces that support functionality between the item listing platform components. The item listing platform operations 830 and item listing platform interfaces 840 can enable communication, coordination and seamless functioning of the item listing system 800.

By way of example, functionality associated with item listing platform 810 can include shopping operations (for example, product search and browsing, product selection and shopping cart, checkout and payment, and order tracking); user account operations (for example, user registration and authentication, and user profiles); seller and product management operations (for example, seller registration and product listing and inventory management); payment and financial operations (for example, payment processing, refunds and returns); order fulfillment operations (for example, order processing and fulfillment and inventory management); customer support and communication interfaces (for example, customer support chat/email and notifications); security and privacy interfaces (for example, authentication and authorization, payment security); recommendation and personalization interfaces (for example, product recommendations and customer reviews and ratings); analytics and report interfaces (for example, sales and inventory reports, and user behavior analytics); and APIs and Integration Interfaces (for example, APIs for Third-Party Integration).

The item listing platform 810 can provide item listing platform databases (for example, item listing platform databases 850) to manage and store different types of data efficiently. The item listing platform databases 850 can include relational databases, NoSQL databases, search databases, cache databases, content management systems, analytics databases, payment gateway database, customer relationship management databases, log and error databases, inventory and supply chain databases, and multi-channel databases that are used in combination to efficiently manage data and provide e-commerce experience for users.

The item listing platform 810 supports applications (for example, applications 860) that is a computer program or software component or service that serves a specific function or set of functions to fulfil a particular item listing platform requirement or user requirement. Applications can be client-side (user-facing) and server-side (backend). Applications can also include application without any AI support (for example, application 862) application supported by traditional AI model (for example, application 864), and applications supported by generative AI models (for example, application 866). By way of example, applications can include an online storefront application, mobile shopping app, admin and management console, payment gateway integration, user account and authentication application, search and recommendation engines, inventory and stock management application, order processing and fulfillment application, customer support and communication tools, content management system, analytics and report applications, marketing and promotion applications, multi-channel integration applications, log and error tracking applications, customer relationship management (CRM) applications, security applications, and APIs and web services that are used in combination to efficiently deliver e-commerce experiences for users.

The items listing platform 810 can include a machine learning engine (for example, machine learning engine 870). The machine learning engine 870 refers to machine learning framework or machine learning platform that provides the infrastructure and tools to design, train, evaluate, and deploy machine learning models. The machine learning engine 870 can serve as the backbone for developing and deploying machine learning applications and solutions. Machine learning engine 870 can also provide tools for visualizing data and model results, as well as interpreting model decisions to gain insights into how the model is making predictions.

The machine learning engine 870 can provide the necessary libraries, algorithms, and utilities to perform various tasks within the machine learning workflow. The machine learning workflow can include data processing, model selection, model training, model evaluation, hyperparameter tuning, scalability, model deployment, inference, integration, customization, data visualization. Machine learning engine 870 can include pre-trained models for various tasks, simplifying the development process. In this way, the machine learning engine 870 can streamline the entire machine learning process, from data preparation and model training to deployment and inference, making it accessible and efficient for different types of users (for example, customers, data scientists, machine learning engineers, and developers) working on a wide range of machine learning applications.

Machine learning engine 870 can be implemented in the item listing system 800 as a component that leverages machine learning algorithms and techniques (for example, machine learning algorithms 872) to enhance various aspects of the item listing system's functionality. Machine learning engine 870 can provide a selection of machine learning algorithms and techniques used to teach computers to learn from data and make predictions or decisions without being explicitly programmed. These techniques are widely used in various applications across different industries, and can include the following examples: supervised learning (for example, linear regression: classification, support vector machines (SVM); unsupervised learning (for example, clustering, principal component analysis (PCA), association rules (for example, apriori); reinforcement learning (for example, Q-Learning, deep Q-Network (DQN); and deep learning (for example, neural networks, convolutional neural networks (CNN), and recurrent neural networks (RNN); and ensemble learning random forest.

Machine learning training data 874 supports the process of building, training, and fine-tuning machine learning models. Machine learning training data 874 consists of a labeled dataset that is used to teach a machine learning model to recognize patterns, make predictions, or perform specific tasks. Training data typically comprises two main components: input feature (X) and labels or target values (Y). Input features can include variables, attributes, or characteristics used as input to the machine learning model. Input features (X) can be numeric, categorical, or even textual, depending on the nature of the problem. For example, in a model for predicting house prices, input features might include the number of bedrooms, square footage, neighborhood, and so on. Labels or target values (Y) include the values that the model aims to predict or classify. Labels represent the desired output or the ground truth for each corresponding set of input features. For instance, in a spam email classifier, the labels would indicate whether each email is spam or not (i.e., binary classification). The training process involves presenting the model with the training data, and the model learns to make predictions or decisions by identifying patterns and relationships between the input features (X) and the target values (Y). A machine learning algorithm adjusts its internal parameters during training in order to minimize the difference between its predictions and the actual labels in the training data. Machine learning engine 870 can use historical and real-time data to train models and make predictions, continually improving performance and user experience.

Machine learning engine 870 can include machine learning models (for example, machine learning models 876) generated using the machine learning engine workflow. Machine learning models 876 can include generative AI models and traditional AI models that can both be employed in the item listing system 800. Generative AI models are designed to generate new data, often in the form of text, images, or other media, based on patterns and knowledge learned from existing data. Generative AI models can be employed in various ways including: content generation, product image generation, personalized product recommendations, natural language chatbots, and content summarization. Traditional AI models encompass a wide range of algorithms and techniques and can be employed in various ways including: recommendation systems, predictive analytics, search algorithms, fraud detection, customer segmentation, image classification, Natural Language Processing (NLP) and A/B testing and optimization. In many cases, a combination of both generative and traditional AI models can be employed to provide a well-rounded and effective e-commerce experience, combining data-driven insights and creativity.

Machine learning engine 870 can be used to analyze data, make predictions, and automate processes to provide a more personalized and efficient shopping experience for users. By way of example, product recommendations search and filtering: pricing optimization, inventory and stock management: customer segmentation, churn prediction and retention, fraud detection, sentiment analysis, customer support and chatbots, image and video analysis, and ad targeting and marketing. The specific applications of machine learning within the item listing platform 810 can vary depending on the specific goals, available data, and resources.

### Example Distributed Computing System Environment

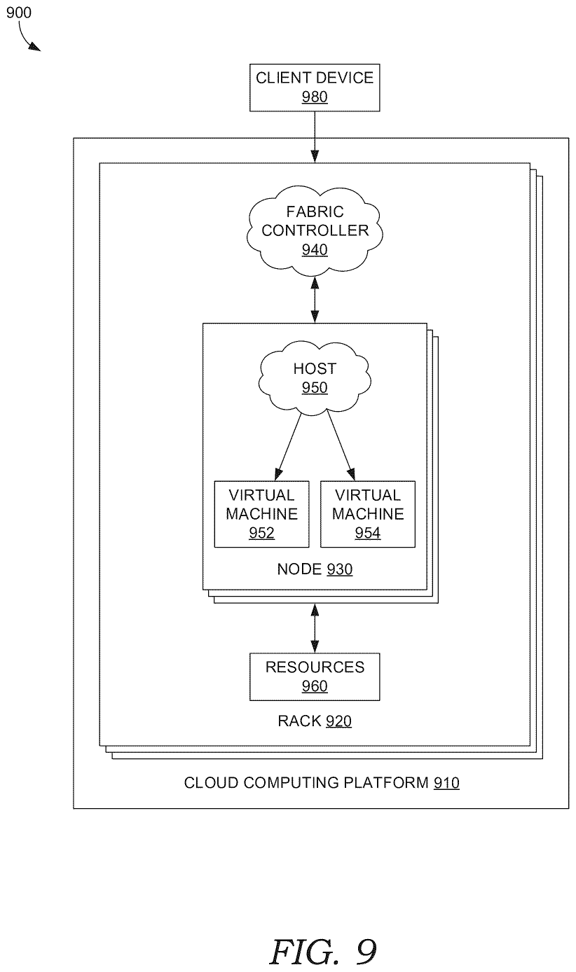

Referring now to FIG. 9, FIG. 9 illustrates an example distributed computing environment 900 in which implementations of the present disclosure may be employed. In particular, FIG. 9 shows a high level architecture of an example cloud computing platform 910 that can host a technical solution environment, or a portion thereof (for example, a data trustee environment). It should be understood that this and other arrangements described herein are set forth only as examples. For example, as described above, many of the elements described herein may be implemented as discrete or distributed components or in conjunction with other components, and in any suitable combination and location. Other arrangements and elements (for example, machines, interfaces, functions, orders, and groupings of functions) can be used in addition to or instead of those shown.

Data centers can support distributed computing environment 900 that includes cloud computing platform 910, rack 920, and node 930 (for example, computing devices, processing units, or blades) in rack 920. The technical solution environment can be implemented with cloud computing platform 910 that runs cloud services across different data centers and geographic regions. Cloud computing platform 910 can implement fabric controller 940 component for provisioning and managing resource allocation, deployment, upgrade, and management of cloud services. Typically, cloud computing platform 910 acts to store data or run service applications in a distributed manner. Cloud computing infrastructure 910 in a data center can be configured to host and support operation of endpoints of a particular service application. Cloud computing infrastructure 910 may be a public cloud, a private cloud, or a dedicated cloud.

Node 930 can be provisioned with host 950 (for example, operating system or runtime environment) running a defined software stack on node 930. Node 930 can also be configured to perform specialized functionality (for example, compute nodes or storage nodes) within cloud computing platform 910. Node 930 is allocated to run one or more portions of a service application of a tenant. A tenant can refer to a customer utilizing resources of cloud computing platform 910. Service application components of cloud computing platform 910 that support a particular tenant can be referred to as a multi-tenant infrastructure or tenancy. The terms service application, application, or service are used interchangeably herein and broadly refer to any software, or portions of software, that run on top of, or access storage and compute device locations within, a datacenter.

When more than one separate service application is being supported by nodes 930, nodes 930 may be partitioned into virtual machines (for example, virtual machine 952 and virtual machine 954). Physical machines can also concurrently run separate service applications. The virtual machines or physical machines can be configured as individualized computing environments that are supported by resources 960 (for example, hardware resources and software resources) in cloud computing platform 910. It is contemplated that resources can be configured for specific service applications. Further, each service application may be divided into functional portions such that each functional portion is able to run on a separate virtual machine. In cloud computing platform 910, multiple servers may be used to run service applications and perform data storage operations in a cluster. In particular, the servers may perform data operations independently but exposed as a single device referred to as a cluster. Each server in the cluster can be implemented as a node.

Client device 980 may be linked to a service application in cloud computing platform 910. Client device 980 may be any type of computing device, which may correspond to computing device 900 described with reference to FIG. 9, for example, client device 980 can be configured to issue commands to cloud computing platform 910. In embodiments, client device 980 may communicate with service applications through a virtual Internet Protocol (IP) and load balancer or other means that direct communication requests to designated endpoints in cloud computing platform 910. The components of cloud computing platform 910 may communicate with each other over a network (not shown), which may include, without limitation, one or more local area networks (LANs) and/or wide area networks (WANs).

### Example Computing Environment

Having briefly described an overview of embodiments of the present invention, an example operating environment in which embodiments of the present invention may be implemented is described below in order to provide a general context for various aspects of the present invention. Referring initially to FIG. 10 in particular, an example operating environment for implementing embodiments of the present invention is shown and designated generally as computing device 1000. Computing device 1000 is but one example of a suitable computing environment and is not intended to suggest any limitation as to the scope of use or functionality of the invention. Neither should computing device 1000 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 10, computing device 1000 includes bus 1010 that directly or indirectly couples the following devices: memory 1012, one or more processors 1014, one or more presentation components 1016, input/output ports 1018, input/output components 1020, and illustrative power supply 1022. Bus 1010 represents what may be one or more buses (such as an address bus, data bus, or combination thereof). The various blocks of FIG. 10 are shown with lines for the sake of conceptual clarity, and other arrangements of the described components and/or component functionality are also contemplated. For example, one may consider a presentation component such as a display device to be an I/O component. Also, processors have memory. We recognize that such is the nature of the art, and reiterate that the diagram of FIG. 10 is merely illustrative of an example computing device that can be used in connection with one or more embodiments of the present invention. Distinction is not made between such categories as “workstation,” “server,” “laptop,” “hand-held device,” etc., as all are contemplated within the scope of FIG. 10 and reference to “computing device.”

Computing device 1000 typically includes a variety of computer-readable media. Computer-readable media can be any available media that can be accessed by computing device 1000 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 1000. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 1012 includes computer storage media in the form of volatile and/or nonvolatile memory. The memory may be removable, non-removable, or a combination thereof. Exemplary hardware devices include solid-state memory, hard drives, optical-disc drives, etc. Computing device 1000 includes one or more processors that read data from various entities such as memory 1012 or I/O components 1020. Presentation component(s) 1016 present data indications to a user or other device. Exemplary presentation components include a display device, speaker, printing component, vibrating component, etc.

I/O ports 1018 allow computing device 1000 to be logically coupled to other devices including I/O components 1020, some of which may be built in. Illustrative components include a microphone, joystick, game pad, satellite dish, scanner, printer, wireless device, etc.

### Additional Structural and Functional Features of Embodiments of the Technical Solution

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (for example, machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present invention are described with reference to a distributed computing environment; however the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present invention may generally refer to the technical solution environment and the schematics described herein, it is understood that the techniques described may be extended to other implementation contexts.

Embodiments of the present invention have been described in relation to particular embodiments which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

What is claimed is:

1. A computer-implemented method comprising:
obtaining a task specification comprising a task and a task input;
performing, using a knowledge-graph component, entity linking to extract task-aware context based, at least in part, on the task specification;
concatenating the task-aware context with the task specification to generate a prompt;
processing, using a large-language model component, the prompt to generate a response to the task specification; and
providing the response to the task specification using a user interface.

2. The computer-implemented method of claim 1, further comprising:
obtaining a knowledge graph from the knowledge-graph component;
extracting a subgraph from the knowledge graph based on the task specification; and
incorporating data from the subgraph into a large-language model obtained from the large-language model component.

3. The computer-implemented method of claim 2, wherein extracting the subgraph from the knowledge graph is a non-agent-based approach comprising:
identifying entities within the knowledge graph;
constructing subgraphs of the knowledge graph based on the identified entities; and
pruning the constructed subgraphs.

4. The computer-implemented method of claim 2, wherein extracting the subgraph from the knowledge graph is an agent-based approach comprising:
using an agent of the large-language model to formulate a retrieval plan based on the task specification;
using a graph database to execute the retrieval plan to produce a set of candidate subgraphs; and
selecting a subgraph from the set of candidate subgraphs as the extracted subgraph.

5. The computer-implemented method of claim 2, wherein incorporating the data from the subgraph into the large-language model is a hard prompt approach comprising:
translating information of the knowledge graph into natural language text; and
appending the natural language text to the prompt.

6. The computer-implemented method of claim 5, wherein appending the natural language text to the prompt comprises knowledge-augmented language model prompting (KAPING).

7. The computer-implemented method of claim 5, wherein appending the natural language text to the prompt comprises graph neural network using retrieval-augmented generation (GNN-RAG).

8. The computer-implemented method of claim 2, wherein incorporating the data from the subgraph into the large-language model is a soft prompt approach comprising converting the data from the subgraph into a latent representation that is consistent with an intrinsic framework of the large-language model.

9. The computer-implemented method of claim 8, wherein converting the data from the subgraph into a latent representation that is consistent with an intrinsic framework of the large-language model comprises:
freezing one or more parameters of the large-language model; and
training a graph neural network (GNN) to generate a trained GNN that outputs an encoding of the subgraph that is consistent with an embedding of the large-language model.

10. The computer-implemented method of claim 9, wherein converting the data from the subgraph into the latent representation that is consistent with the intrinsic framework of the large-language model further comprises augmenting the trained GNN with cross-modality pooling and a projection mechanism to introduce self-supervised entity-linked prediction loss to capture inter-entity relations of the subgraph.

11. A computer system comprising:
one or more processors; and
one or more computer storage medium storing computer-usable instructions that, when used by the one or more processors, causes the computer system to perform operations comprising:
obtaining a task specification comprising a task, a task input, and a task result format;
performing, using a knowledge-graph component, entity linking to extract task-aware context based, at least in part, on the task specification;
concatenating the task-aware context with the task specification to generate a prompt;
processing, using a large-language model component, the prompt to generate a response to the task specification; and
providing the response to the task specification in the task result format, using a user interface.

12. The computer system of claim 11, the operations further comprising:
obtaining a knowledge graph from the knowledge-graph component;
extracting a subgraph from the knowledge graph based on the task specification; and
incorporating data from the subgraph into a large-language model obtained from the large-language model component.

13. The computer system of claim 11, wherein the task is to generate a search query specified by the task input to be executed by the large-language model component.

14. The computer system of claim 11, wherein the response is used to generate a second prompt that is processed by the large-language model component to generate a second response.

15. The computer system of claim 11, wherein the task-aware context comprises one or more entity triples selected, based at least in part, on a score for each entity calculated using the task specification.

16. One or more computer storage media storing computer-usable instructions that, when used by one or more computing devices, cause the one or more computing devices to perform operations, the operations comprising:
obtaining a task specification comprising a task and a task input;
performing, using a knowledge-graph component, entity linking to extract task-aware context based, at least in part, on the task specification;
concatenating the task-aware context with the task specification to generate a prompt;
processing, using a large-language model component, the prompt to generate a response to the task specification; and
providing the response to the task specification using a user interface.

17. The computer storage media of claim 16, the operations further comprising:
obtaining a knowledge graph from the knowledge-graph component;
extracting a subgraph from the knowledge graph based on the task specification; and
incorporating data from the subgraph into a large-language model obtained from the large-language model component.

18. The computer storage media of claim 16, wherein the task specification is described in a natural language format.

19. The computer storage media of claim 16, wherein the task specification further comprises a task result format and the response is provided using the task result format.

20. The computer storage media of claim 16, wherein the knowledge-graph component comprises a relationship-rich product knowledge graph which captures entities and relationships between the entities of an item listing system and the relationship-rich product knowledge graph is generated from data provided by users of the item listing system.
